(19) United States
(12) Patent Application Publication
(10) Pub. No.: US 2024/0346896 A1
(43) Pub. Date: Oct. 17, 2024

(54) HAPTIC DEVICE

(71) Applicant: Murata Manufacturing Co., Ltd., Kyoto (JP)

(72) Inventor: Masaru MATSUURA, Kyoto (JP)

(21) Appl. No.: 18/752,224

(22) Filed: Jun. 24, 2024

Related U.S. Application Data
(63) Continuation of application No. PCT/JP2022/044880, filed on Dec. 6, 2022.

(30) Foreign Application Priority Data
Dec. 27, 2021 (JP) 2021-213341

(51) Int. Cl. G08B 6/00

(52) U.S. Cl. CPC G08B 6/00

(57) ABSTRACT

The haptic device includes a housing and a vibration body accommodated in the housing. The haptic device includes a control device capable of presenting at least one of a tactile sensation and a force sensation to a user by controlling a vibration pattern of the vibration body. In addition, the haptic device includes a band including a first portion that is fixed to an outer surface of the housing. In the haptic device, a body of the user is able to be attached between an abutting portion of the band that is a portion different from the first portion, and a contact surface that is a part of the outer surface of the housing.

### CROSS REFERENCE TO RELATED APPLICATION

This is a continuation of International Application No. PCT/JP2022/044880 filed on Dec. 6, 2022 which claims priority from Japanese Patent Application No. 2021-213341 filed on Dec. 27, 2021. The contents of these applications are incorporated herein by reference in their entireties.

### BACKGROUND OF THE DISCLOSURE

### Field of the Disclosure

The present disclosure relates to a haptic device.

### Description of the Related Art

The game machine described in Patent Document 1 includes a display that displays an image and a controller for operating an operation target in a game. The controller includes operation units to be operated by the user such as an operation knob and a switching button.

The haptic device described in Patent Document 2 includes a housing, a vibration body, and a control device. The vibration body is located inside the housing. The housing is used by being gripped by the hand of the user, for example. The control device presents a force sensation proceeding in a specific direction by controlling a vibration pattern of the vibration body. As a result, the user who is gripping the housing feels such a force sensation that the user feels as if the haptic device is moving in the specific direction.
Patent Document 1: Japanese Unexamined Patent Application Publication No. 2000-61136
Patent Document 2: Japanese Unexamined Patent Application Publication No. 2005-190465

### BRIEF SUMMARY OF THE DISCLOSURE

In the game machine described in Patent Document 1, feedback by using a force sensation may be desired to be given in accordance with the operation of the controller performed by the user, an image displayed on the display, or the like. Similarly, feedback of a tactile sensation such as a rough feeling or an uneven feeling may be desired to be given in accordance with an image displayed on the display. However, in order to give feedback by using such a tactile sensation and a force sensation (hereinafter, referred to as a tactile force), a vibration body similar to the vibration body of the haptic device described in Patent Document 2 needs to be incorporated in the controller. Therefore, in order to receive feedback by using a tactile force, a user who already owns a game machine has no choice but to replace the game machine with a game machine in which a vibration body is incorporated. Here, although a game machine is exemplified, when tactile force feedback is desired to be given using a controller, a problem similar to that in a game machine arises.

To solve the above-described problem, an aspect of the present disclosure is a haptic device which includes a housing, a vibration body accommodated in the housing, a control device capable of presenting at least one of a tactile sensation and a force sensation to a user by controlling a vibration pattern of the vibration body, and a band including a first portion that is fixed to an outer surface of the housing, and a body of the user is able to be attached between an abutting portion of the band that is a portion different from the first portion and a contact surface that is a part of the outer surface of the housing.

According to the above-described configuration, a body such as a finger can be inserted between the abutting portion of the band and the contact surface of the housing. In addition, in a state in which the body such as a finger is inserted, the contact surface of the housing touches the body. Therefore, since vibration of the vibration body can be transmitted to the body through the outer surface of the housing, a tactile sensation or a force sensation can be presented to the user. In addition, according to the above-described configuration, since the haptic device can be attached to the body by the band, the user can receive tactile sensation or force sensation presentation from the haptic device while gripping a controller or the like, for example. That is, the user can receive tactile sensation or force sensation feedback by using the haptic device together with a controller or the like that does not have a tactile sensation or force sensation presentation function.

The present disclosure can give tactile sensation or force sensation feedback in combination with a controller or the like that does not have a tactile sensation or force sensation presentation function.

### BRIEF DESCRIPTION OF THE SEVERAL VIEWS OF THE DRAWINGS

FIG. 1 is a plan view of a haptic device of an embodiment.

FIG. 2 is a side view of the haptic device of the embodiment.

FIG. 3 is a view illustrating a state in which the haptic device of the embodiment is worn by a user.

FIG. 4 is a view illustrating a state in which the haptic device of the embodiment is worn by the user.

FIG. 5 is a plan view of a haptic device of a modification.

FIG. 6 is a side view of the haptic device of the modification.

FIG. 7 is a plan view of a haptic device of another modification.

FIG. 8 is a side view of the haptic device of the other modification.

### DETAILED DESCRIPTION OF THE DISCLOSURE

Hereinafter, an embodiment of a haptic device will be described with reference to the drawings. The drawings may illustrate components in an enlarged manner for facilitating understanding. Dimensional ratios of the components may be different from actual ratios or ratios in different drawings.

### (Overall Configuration)

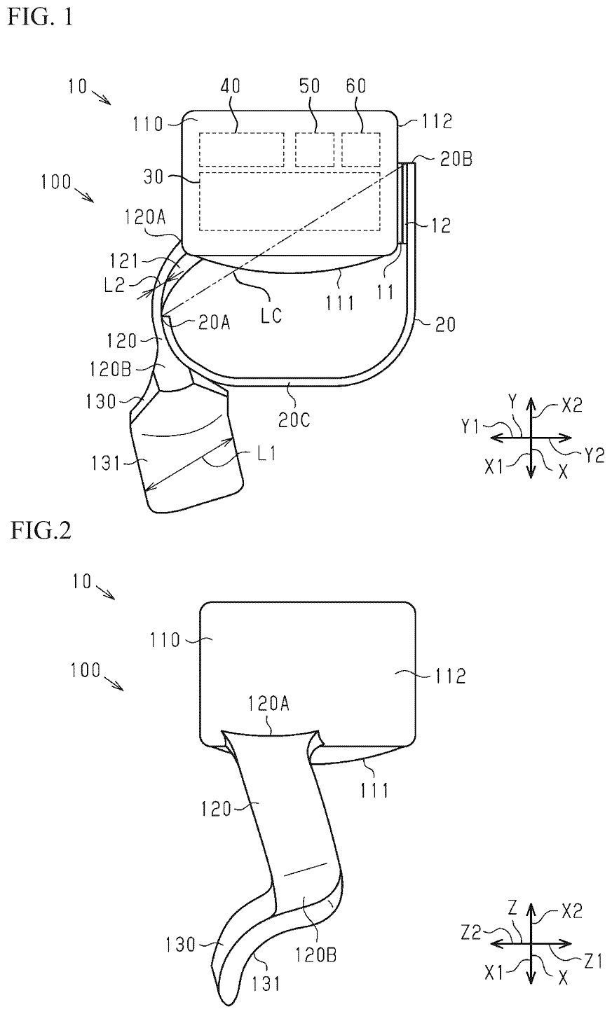

As illustrated in FIG. 1, a haptic device 10 includes a housing 100, a band 20, and a vibration body 30.

The housing 100 includes a main body portion 110, a projecting portion 120, and a wide portion 130. The main body portion 110 has a columnar shape. In addition, the main body portion 110 is hollow inside.

Here, an axis parallel to a central axial line of the columnar main body portion 110 is a first axis X. In addition, one of axes orthogonal to the first axis X is a second axis Y. In addition, an axis orthogonal to both the first axis X and the second axis Y is a third axis Z. Moreover, one of the directions extending along the first axis X is a first positive direction X1, and an opposite direction of the first positive direction X1, of the directions extending along the first axis X, is a first negative direction X2. In addition, one of the directions extending along the second axis Y is a second positive direction Y1, and an opposite direction of the second positive direction Y1, of the directions extending along the second axis Y, is a second negative direction Y2. In addition, one of the directions extending along the third axis Z is a third positive direction Z1, and an opposite direction of the third positive direction Z1, of the directions extending along the third axis Z, is a third negative direction Z2.

The main body portion 110 includes a contact surface 111, which is a part of an outer surface of the housing 100, and an outer peripheral surface 112 having a circumferential shape. The contact surface 111 faces in the first positive direction X1. The contact surface 111 is a curved surface projecting in the first positive direction X1. The contact surface 111 is expanded the most toward the first positive direction X1 side at the center. The outer peripheral surface 112 is a peripheral surface adjacent to the contact surface 111.

The projecting portion 120 has a band shape. The projecting portion 120 projects from the main body portion 110. A base end 120A, which is an end of the projecting portion 120 on the main body portion 110 side, is located at an end portion, on the first positive direction X1 side, of the outer peripheral surface 112 of the main body portion 110. In addition, the base end 120A is located at an end portion, on the second positive direction Y1 side, of the outer peripheral surface 112 of the main body portion 110. The projecting portion 120 projects from the base end 120A toward the first positive direction X1 side. In addition, the projecting portion 120 is curved so as to project in the second positive direction Y1. By reflecting the shape of the projecting portion 120, an inner peripheral surface 121 of the projecting portion 120 facing in the second negative direction Y2 is a curved surface projecting in the second positive direction Y1. The length from the base end 120A to a leading end 120B on a side opposite to the base end 120A in the projecting portion 120 is equal to or more than 1 cm and equal to or less than 3 cm.

The wide portion 130 is attached to the leading end 120B of the projecting portion 120. Note that a specific shape of the wide portion 130 will be described later.

The housing 100 including the main body portion 110, the projecting portion 120, and the wide portion 130 is an integrally molded product. The material of the housing 100 is a thermosetting resin such as a phenol resin, a urea resin, a melamine resin, or an unsaturated polyester resin.

The band 20 has a band shape. The material of the band 20 is silicone rubber. Therefore, the band 20 is elastic. In addition, the bending rigidity of the band 20 is less than the bending rigidity of the projecting portion 120 in the housing 100. Note that the bending rigidity of the band 20 and the projecting portion 120 may be measured by a three-point bending test described below. That is, both ends of the band 20 or the projecting portion 120 to be tested are supported from below. Then, in this state, a downward load is applied to the center of the test target from above. Then, the load is measured when a certain deformation occurs in the test target. The larger the load measured in this manner is, the larger the bending rigidity is.

A first portion 20A of the band 20 is fixed to the outer surface of the housing 100 with an adhesive or the like. Specifically, the first portion 20A of the band 20 is fixed to the inner peripheral surface 121 of the projecting portion 120. That is, the first portion 20A of the band 20 is adjacent to the projecting portion 120. In addition, the band 20 as a whole is located on the first positive direction X1 side with respect to the main body portion 110. Note that in the present embodiment, the first portion 20A of the band 20 is an end portion of the band 20.

The band 20 includes a second portion 20B, which is a portion different from the first portion 20A. In the present embodiment, the second portion 20B of the band 20 is an end portion of the band 20 on an opposite side of the first portion 20A. The second portion 20B is fixed to a portion, of the outer surface of the housing 100, different from a portion to which the first portion 20A is fixed. Specifically, the haptic device 10 includes a first hook-and-loop fastener 11 and a second hook-and-loop fastener 12. The first hook-and-loop fastener 11 is located at an end portion, of the outer peripheral surface 112 of the main body portion 110, on the second negative direction Y2 side. On the other hand, the second hook-and-loop fastener 12 is located in the second portion 20B of the band 20. In addition, the second hook-and-loop fastener 12 is located on a surface side, of the band 20, facing the main body portion 110. The second hook-and-loop fastener 12 can be attached to and detached from the first hook-and-loop fastener 11.

The band 20 includes an abutting portion 20C, which is a portion different from the first portion 20A and the second portion 20B. The abutting portion 20C is a portion, of the band 20, extending from the first portion 20A to the second portion 20B. In a state in which the second portion 20B of the band 20 is fixed to the main body portion 110, the abutting portion 20C faces the contact surface 111 of the main body portion 110. That is, the contact surface 111 projects toward the abutting portion 20C.

The band 20 has a length of 7 cm from the first portion 20A to the second portion 20B. Note that the length of the band 20 from the first portion 20A to the second portion 20B is the shortest distance from a position, of the first portion 20A, closest to the second portion 20B to the second portion 20B when the band 20 is followed. In addition, the length of the band 20 from the first portion 20A to the second portion 20B is appropriate when the band 20 is wrapped around approximately two to four fingers as long as the length is equal to or more than 3 cm and equal to or less than 15 cm.

In a state in which the second portion 20B of the band 20 is fixed to the main body portion 110, the contact surface 111 of the main body portion 110, a part of the projecting portion 120 on the base end 120A side, and the band 20 including the abutting portion 20C constitute an annular portion.

The vibration body 30 is accommodated in the housing 100. Specifically, the vibration body 30 is accommodated inside the main body portion 110. Although not illustrated, the vibration body 30 includes a voice coil motor, a weight corresponding to each voice coil motor, and a cubic case accommodating the voice coil motor and the weight. By a force generated when a current passes through a coil of the voice coil motor, the weight is vibrated. When the weight vibrates, the case is vibrated by the vibration of the weight. Therefore, when the current passing through the coil of the voice coil motor is controlled, the vibration body 30 vibrates in a direction along the second axis Y and a direction along the third axis Z. More specifically, the vibration body 30 is a vibration body similar to the one described in, for example, Japanese Unexamined Patent Application Publication No. 2005-190465.

The haptic device 10 further includes a control device 40, a battery 50, and a communication device 60.

The control device 40 is accommodated in the housing 100. Specifically, the control device 40 is accommodated inside the main body portion 110. The control device 40 controls a vibration pattern of the vibration body 30 so as to be able to generate a force sensation in the vibration body 30. In the present embodiment, as the direction of the force sensation generated from the vibration body 30, any one of the second positive direction Y1, the second negative direction Y2, the third positive direction Z1, and the third negative direction 22 can be selected. Moreover, the control device 40 controls the vibration pattern of the vibration in a direction along the one axis described above so as to generate a force sensation in one direction or another direction along the axis. Note that the force sensation is a sense of feeling regarding resisting force received from an object. Therefore, for example, when a force sensation in the second positive direction Y1 is generated in the vibration body 30, although the vibration body 30 actually reciprocates at the same position, the user feels as if the vibration body 30 is moving in the second positive direction Y1.

The control device 40 can be configured as circuitry including one or more processors that execute various processing according to a computer program (software). Note that the control device 40 may be configured as one or more pieces of dedicated hardware circuitry such as an application specific integrated circuit (ASIC) or the like that execute at least a part of various processing, or as circuitry including a combination thereof. The processor includes a CPU and a memory such as RAM and ROM. The memory stores a program code or a command configured to cause the CPU to execute processing. The memory, that is, a computer readable medium includes any usable medium that can be accessed by a general or a dedicated computer.

The battery 50 is a repeatedly rechargeable secondary battery. The battery 50 is accommodated in the housing 100. Specifically, the battery 50 is accommodated inside the main body portion 110. The battery 50 supplies power to the vibration body 30. In addition, power can be supplied to the battery 50 through a connected power cable (not illustrated).

The communication device 60 is accommodated in the housing 100. Specifically, the communication device 60 is accommodated inside the main body portion 110. The communication device 60 can wirelessly communicate with a communication device outside the haptic device 10. The communication device 60 can communicate with, for example, a communication device mounted in a controller of a game machine. The communication device 60 can receive a signal output according to operation of an operation key of the controller or the like. In addition, upon receiving the signal from the controller, the communication device 60 outputs a signal related to operation of the controller to the control device 40. Upon receiving the signal from the communication device 60, the control device 40 determines the vibration pattern of the vibration body 30, that is, a direction of a force sensation and strength of the force sensation.

### (Wide Portion of Housing)

As described above, the wide portion 130 is attached to the leading end 120B of the projecting portion 120. The wide portion 130 has a substantially plate shape. Here, in the wide portion 130, a surface on a side opposite to the projecting portion 120 is a leading end surface 131. In addition, it is assumed that a virtual straight line LC passing through the first portion 20A and the second portion 20B of the band 20 is drawn. At this time, a maximum dimension L1 of the wide portion 130 in a direction parallel to the virtual straight line LC is larger than a minimum dimension L2 of the projecting portion 120 in the direction parallel to the virtual straight line LC. Note that the minimum dimension L2 of the projecting portion 120 is a thickness dimension of the projecting portion 120.

As illustrated in FIG. 2, the wide portion 130 extends while being curved toward the third negative direction Z2 side and the first positive direction X1 side with respect to the leading end 120B of the projecting portion 120. In addition, when viewed in a direction along the virtual straight line LC, the wide portion 130 projects toward the third negative direction Z2 side and the first negative direction X2 side. Therefore, when viewed in the direction along the virtual straight line LC, the wide portion 130 includes the leading end surface 131 projecting toward the main body portion 110 side. The curvature of the wide portion 130 is gradually increased as progressing in the third negative direction Z2. An end of the wide portion 130 on the third negative direction Z2 side substantially faces in the first positive direction X1.

Effects of the present embodiment will be described.

### (Wearing of Haptic Device)

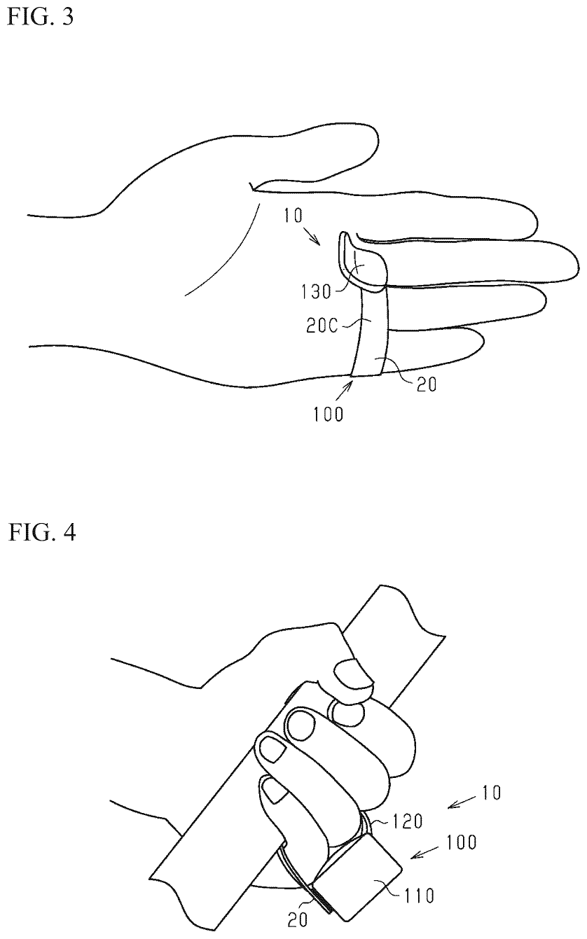

As illustrated in FIG. 3, the user inserts the fourth finger and the fifth finger of the left hand into an annular portion formed with the housing 100 and the band 20 of the haptic device 10. At this time, the user brings the base portion of the fourth finger and the fifth finger on the back side of the left hand into contact with the contact surface 111 of the main body portion 110. In addition, the user brings the base portion of the fourth finger and the fifth finger on the palm side of the left hand into contact with the abutting portion 20C of the band 20. That is, in the haptic device 10, the body of the user can be attached between the abutting portion 20C and the contact surface 111.

In addition, the user holds the projecting portion 120 between the third finger and the fourth finger. In this state, the wide portion 130 is located on the palm side. The wide portion 130 extends from the base of the fourth finger toward the palm side. In addition, the wide portion 130 is curved such that the palm side projects. Then, the second portion 20B of the band 20 is attached to the main body portion 110 such that the band 20 tightens the fourth finger and the fifth finger.

As illustrated in FIG. 4, it is assumed that, in a state in which the haptic device 10 is worn on the fingers, the user grips a cylindrical portion of a controller or the like. At this time, the leading end surface 131 of the wide portion 130 comes into contact with an outer surface of the controller. When the vibration body 30 vibrates in this state, the main body portion 110 vibrates with a portion at which the leading end surface 131 of the wide portion 130 comes into contact with the hand as a fulcrum. In addition, the vibration is transmitted to the fingers through the main body portion 110 located on the back side of the hand.

### Effects of Present Embodiment

(1) According to the above-described embodiment, the fingers can be inserted between the abutting portion 20C and the contact surface 111. In addition, in a state in which the fingers are inserted, the contact surface 111 of the housing 100 touches the fingers. Therefore, since the vibration of the vibration body 30 can be transmitted to the fingers through the outer surface of the housing 100, the force sensation can be presented to the user. In addition, according to the above-described configuration, since the haptic device 10 can be attached to the fingers by the band 20, the user can receive the presentation of the force sensation from the haptic device 10 while gripping a controller or the like, for example. That is, the user can receive the feedback of the force sensation by using the haptic device 10 together with a controller or the like that does not have a force sensation presentation function.

(2) According to the above-described embodiment, the first portion 20A and the second portion 20B of the band 20 are fixed to different portions of the housing 100. In addition, fingers or the like of the user can be inserted into an annular portion formed with the housing 100 and the band 20. Since the fingers or the like of the user can be attached to the annular portion in this manner, the haptic device 10 does not easily come off even when the user moves the fingers.

(3) In the above-described embodiment, the band 20 has a length of 7 cm from the first portion 20A to the second portion 20B. According to this configuration, the length is suitable for attaching the haptic device 10 to fingers that are sensitive to vibration or the like.

(4) According to the above-described embodiment, the fingers, the palm, and the like that are not inserted into the annular portion formed with the band 20 and the housing 100 can support the projecting portion 120. In addition, when the projecting portion 120 having relatively high bending rigidity is supported, the orientation of the entire haptic device 10 is stabilized.

(5) In the above-described embodiment, the first portion 20A of the band 20 is adjacent to the projecting portion 120. According to the configuration, the projecting portion 120 can be held and supported together with a part of the band 20 between the fingers inserted into the annular portion formed with the band 20 and the housing 100 and the fingers not inserted into the annular portion.

(6) In the above-described embodiment, the maximum dimension L1 of the wide portion 130 in the direction parallel to the virtual straight line LC is larger than the minimum dimension L2 of the projecting portion 120 in the direction parallel to the virtual straight line LC. According to the configuration, when the wide portion 130 is brought into contact with the fingers, the palm, and the like, the wide portion 130 can be supported in a wide area. Therefore, the orientation of the haptic device 10 is further stabilized.

(7) In the above-described embodiment, when viewed in a direction along the virtual straight line LC, the wide portion 130 includes the leading end surface 131 projecting toward the main body portion 110 side. According to the configuration, when the hand to which the haptic device 10 is attached grips a cylindrical controller or the like, the leading end surface 131 of the wide portion 130 conforms to an outer surface of the controller. Therefore, the wide portion 130 can be supported by being caught between the fingers and the controller that is gripped.

(8) In the above-described embodiment, the contact surface 111 has a curved surface projecting toward the abutting portion 20C side. According to the configuration, when the fingers or the like are inserted into the annular portion formed with the housing 100 and the band 20, the contact surface 111 can be brought into close contact with the fingers or the like. Therefore, the force sensation presented by the haptic device 10 can be efficiently transmitted to the user.

### (Modification)

The above-described embodiment can be modified as below. The above-described embodiment and the following modifications can be combined within a technically possible range.
In the above-described embodiment, the control device 40 may vibrate the vibration body 30 with a vibration pattern that generates a tactile sensation such as a rough feeling or an uneven feeling in addition to or in place of the vibration pattern that can generate a force sensation. Note that the above-described tactile sensations can be presented to the user through, for example, adjusting of an intensity distribution of resisting force generated by the vibration body 30.
In the above-described embodiment, the shape of the wide portion 130 may be appropriately changed. For example, the leading end surface 131 of the wide portion 130 may be a plane surface.

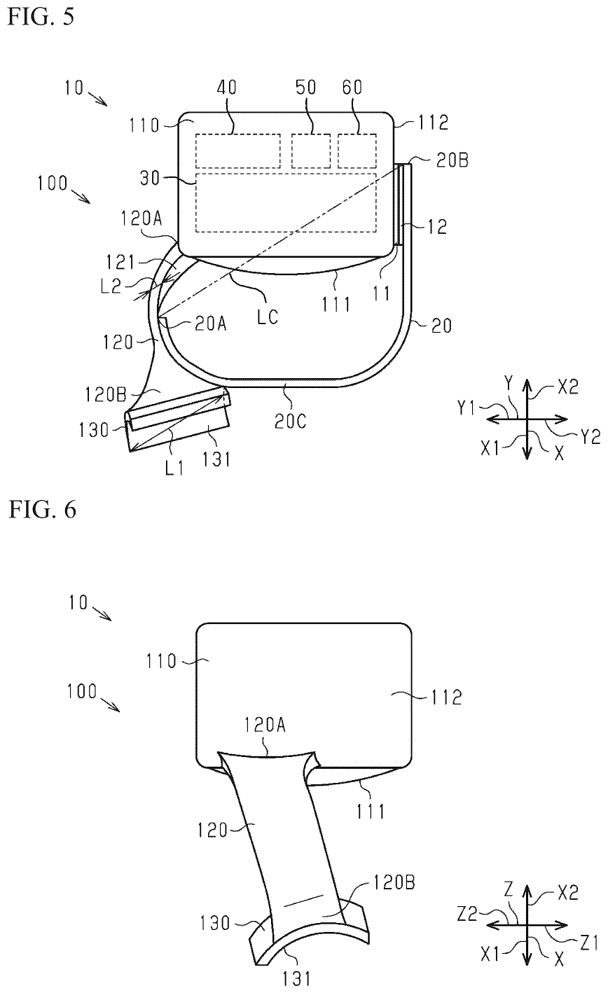

In addition, for example, the shape of the wide portion 130 may be the shape illustrated in FIGS. 5 and 6. In the example illustrated in FIG. 5, the wide portion 130 is attached to the leading end 120B of the projecting portion 120. The wide portion 130 has a substantially plate shape. In addition, in the haptic device 10 illustrated in FIG. 5, as with the above-described embodiment, it is assumed that the virtual straight line LC passing through the first portion 20A and the second portion 20B of the band 20 is drawn. At this time, the maximum dimension L1 of the wide portion 130 in a direction parallel to the virtual straight line LC is larger than the minimum dimension L2 of the projecting portion 120 in the direction parallel to the virtual straight line LC.

As illustrated in FIG. 6, a surface, of the outer surface of the wide portion 130, on a side opposite to the projecting portion 120 is the leading end surface 131. When viewed in a direction along the virtual straight line LC, the leading end surface 131 is a curved surface having a circular arc shape projecting toward the first negative direction X2 side. That is, when viewed in the direction along the virtual straight line LC, the wide portion 130 has the leading end surface 131 projecting toward the main body portion 110 side. In addition, when viewed in the direction along the virtual straight line LC, the wide portion 130 projects, with respect to the projecting portion 120, in both directions of the direction orthogonal to the virtual straight line LC on the third positive direction Z1 side and the third negative direction Z2 side. In other words, the wide portion 130 projects toward both sides with respect to the projecting portion 120 in a direction along a central axial line of an annular portion formed with the contact surface 111 of the main body portion 110, a part of the projecting portion 120 on the base end 120A side, and the band 20.

In the example illustrated in FIGS. 5 and 6, when the haptic device 10 is worn on the fingers as described above, the wide portion 130 extends from the base of the fourth finger toward the palm side and the fingertip side. That is, the user can support the wide portion 130 with both the palm and fingers. Therefore, the orientation of the haptic device 10 is stabilized.

In addition, in a state in which the haptic device 10 is worn on the fingers, the leading end surface 131 projects toward the palm side. Therefore, in a state in which the haptic device 10 is worn by the user, when the user grips a cylindrical member, the curve of the leading end surface 131 and the outer surface of the cylindrical member easily fit. Therefore, even in a state in which the user grips the cylindrical member, the orientation of the haptic device 10 is easily stabilized.

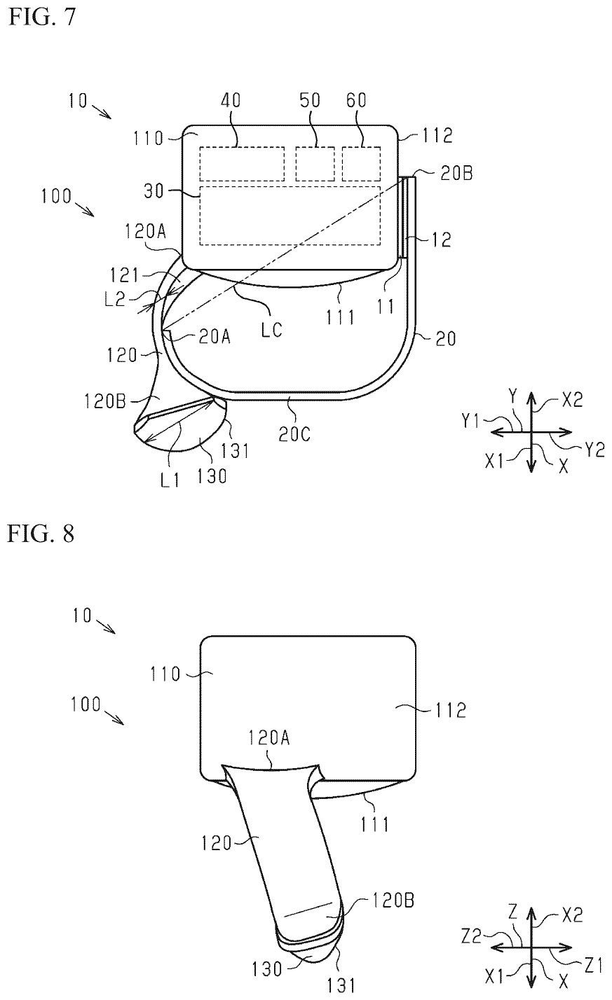

In addition, for example, the shape of the wide portion 130 may be the shape illustrated in FIGS. 7 and 8. As illustrated in FIG. 7, the wide portion 130 is attached to the leading end 120B of the projecting portion 120. The wide portion 130 has a substantially hemispherical shape. When viewed in a direction along the virtual straight line LC, the wide portion 130 has the leading end surface 131 projecting toward a side opposite to the main body portion 110. Note that specifically, the leading end surface 131 is a curved surface projecting substantially in the first positive direction X1.

In the haptic device 10 illustrated in FIG. 7, as with the above-described embodiment, it is assumed that the virtual straight line LC passing through the first portion 20A and the second portion 20B of the band 20 is drawn. At this time, the maximum dimension L1 of the wide portion 130 in a direction parallel to the virtual straight line LC is larger than the minimum dimension L2 of the projecting portion 120 in the direction parallel to the virtual straight line LC.

In the example illustrated in FIGS. 7 and 8, when the haptic device 10 is worn on the fingers as described above, the leading end surface 131 of the wide portion 130 substantially comes into point contact or line contact with an outer surface of an object that is gripped by the palm and fingers. Therefore, when the vibration body 30 vibrates, the vibration body 30 easily vibrates with a portion at which the leading end surface 131 of the wide portion 130 comes into contact with the palm or the like as a fulcrum.
The shape of the main body portion 110 is not limited to the example of the above-described embodiment. The shape of the main body portion 110 may be, for example, a rectangular parallelepiped shape or a spherical shape. The shape need only have a space in which the vibration body 30 or the like can be accommodated in the main body portion 110. In addition, in the above-described embodiment, the contact surface 111 of the main body portion 110 does not have to be a curved surface projecting toward the band 20 side.
The shape of the projecting portion 120 is not limited to the example of the above-described embodiment. The projecting portion 120 may have a flat plate shape that is not curved. In addition, in the above-described embodiment, the length from the base end 120A to the leading end 120B in the projecting portion 120 may be shorter than 1 cm or longer than 3 cm.
The position of the projecting portion 120 is not limited to the example of the above-described embodiment. That is, the base end 120A of the projecting portion 120 may be connected to the main body portion 110 at a position different from the position in the above-described embodiment. For example, the base end 120A may be connected to a central portion of the contact surface 111. Even in such a case, the haptic device 10 can be worn when the projecting portion 120 is held between fingers. In addition, the projecting portion 120 may be adjacent to the second portion 20B of the band 20.
In the above-described embodiment, the main body portion 110, the projecting portion 120, and the wide portion 130 do not have to be integrally formed. In addition, the materials of the main body portion 110, the projecting portion 120, and the wide portion 130 may be different from each other.
In the above-described embodiment, the bending rigidity of the projecting portion 120 may be the same as or less than the bending rigidity of the band 20. However, in terms of stabilizing the wearing orientation of the haptic device 10 by using the projecting portion 120, the projecting portion 120 may have such a degree of bending rigidity that the projecting portion 120 is not bent or curved by the weight of the projecting portion 120.
In the above-described embodiment, the housing 100 does not have to include the wide portion 130. In addition, the housing 100 does not have to include the projecting portion 120 and the wide portion 130. Even the haptic device 10 in which the housing 100 includes only the main body portion 110 can exhibit at least effects related to (1) described above.
In the above-described embodiment, the shape of the band 20 may be appropriately changed. The shape of the band 20 need only have the shape that can be worn on the wearing target such as fingers. For example, the band 20 may be a string.
The positions of the first portion 20A and the second portion 20B of the band 20 with respect to the housing 100 are not limited to the positions in the above-described embodiment. For example, the first portion 20A and the second portion 20B of the band 20 may be attached to the contact surface 111 of the main body portion 110.
In the above-described embodiment, as with the second portion 20B, the first portion 20A of the band 20 may be removably attached to the housing 100.
In the above-described embodiment, the first portion 20A of the band 20 may be detachably attached to the housing 100. For example, the first portion 20A of the band 20 may be attached to the housing 100 with a hook-and-loop fastener.
In the above-described embodiment, the band 20 may be fixed to the housing 100 with the first portion 20A only. In this case, the band 20 need only have some degree of rigidity, and a gap through which fingers or the like can be inserted need only be secured between the abutting portion 20C and the contact surface 111. In this modification, the haptic device 10 can be attached to the body of the user through putting of the fingers or the like between the housing 100 and the band 20.
In the above-described embodiment, the second portion 20B of the band 20 may be fixed to the housing 100, instead of being detachable. For example, the second portion 20B of the band 20 may be fixed to the housing 100 with an adhesive. In addition, in the above-described embodiment, the second portion 20B of the band 20 may be detachably attached by an attachment method other than a hook-and-loop fastener.
In the above-described embodiment, the first portion 20A and the second portion 20B do not have to be end portions of the band 20.
In the above-described embodiment, the length of the band 20 from the first portion 20A to the second portion 20B may be appropriately changed. As described above, in terms of wearing the haptic device 10 on two to four fingers, the band 20 may have a length of equal to or more than 3 cm and equal to or less than 15 cm from the first portion 20A to the second portion 20B. In addition, even when the length of the band 20 is variable in a case where the band 20 is a string that can be wound or the like, the band 20 may have a length of equal to or more than 3 cm and equal to or less than 15 cm from the first portion 20A to the second portion 20B with respect to the housing 100. On the other hand, in terms of wearing the haptic device 10 on a portion thicker than four fingers, the band 20 may have a length of longer than 15 cm from the first portion 20A to the second portion 20B. The length of the band 20 may be changed according to a portion of the user on which the haptic device 10 is worn.
In the above-described embodiment, the vibration body 30 may vibrate only in a direction along the second axis Y, or may vibrate only in a direction along the third axis Z. In addition, in the above-described embodiment, the vibration body 30 may vibrate further in a direction along the first axis X. Accordingly, the control device 40 can control the vibration pattern that vibrates the vibration body 30 in a direction along an axis in which the vibration body 30 can vibrate.
The configuration of the vibration body 30 is not limited to the above-described configuration. For example, the vibration body 30 may use vibration by a motor, or may include a piezoelectric element.
In the above-described embodiment, the control device 40 may be located outside the housing 100.

The haptic device 10 of the above-described embodiment is not limited to being worn on the fourth finger and the fifth finger of the left hand. For example, the haptic device 10 of the above-described embodiment may be worn on the second finger and the third finger of the left hand. Alternatively, the haptic device 10 of the above-described embodiment may be worn on the right hand such that the inner peripheral surface 121 of the projecting portion 120 conforms to the fifth finger of the right hand. The wearing method of the haptic device 10 described in the above-described embodiment is merely an example.
In the above-described embodiment, the battery 50 may be included outside the housing 100.
In the above-described embodiment, the communication device 60 is not limited to being wirelessly communicable. That is, the communication device 60 may be capable of performing cable communication. In this case, the communication device 60 may be connected to, for example, a controller or a game machine with a cable. In addition, the communication device 60 can be omitted.
L1 maximum dimension
L2 minimum dimension
LC virtual straight line
10 haptic device
20 band
20A first portion
20B second portion
30 vibration body
40 control device
100 housing
110 main body portion
111 contact surface
112 outer peripheral surface
120 projecting portion
120A base end
120B leading end
130 wide portion
131 leading end surface

1. A haptic device comprising:
a housing;
a vibration body accommodated in the housing;
a control device configured to present at least one of a tactile sensation and a force sensation to a user by controlling a vibration pattern of the vibration body; and
a band including a first portion fixed to an outer surface of the housing, wherein
a body of the user is attachable between an abutting portion of the band being a portion different from the first portion and a contact surface being a part of the outer surface of the housing.

2. The haptic device according to claim 1, wherein
the band includes a second portion being different from the first portion and fixed to a portion, of the outer surface of the housing, different from a portion to which the first portion is fixed, and
the abutting portion extends from the first portion to the second portion of the band.

3. The haptic device according to claim 2, wherein
the band has a length of equal to or more than 3 cm and equal to or less than 15 cm from the first portion to the second portion.

4. The haptic device according to claim 3, wherein
the housing includes a main body portion accommodating the vibration body and a projecting portion projecting from an outer surface of the main body portion, and
the projecting portion has bending rigidity being larger than bending rigidity of the band.

5. The haptic device according to claim 4, wherein
the first portion of the band is adjacent to the projecting portion.

6. The haptic device according to claim 4, wherein
the housing further includes a wide portion at a leading end, of the projecting portion, on a side opposite to a base end, the base end being an end on the main body portion side, and
when a virtual straight line passing through the first portion and the second portion of the band is drawn, a maximum dimension of the wide portion in a direction parallel to the virtual straight line is larger than a minimum dimension of the projecting portion in the direction parallel to the virtual straight line.

7. The haptic device according to claim 6, wherein
when viewed in a direction along the virtual straight line, the wide portion has a curved surface projecting toward a side of the main body portion.

8. The haptic device according to claim 6, wherein
when viewed in a direction along the virtual straight line, the wide portion has a curved surface projecting toward a side opposite to the main body portion.

9. The haptic device according to claim 1, wherein
the housing includes a main body portion accommodating the vibration body,
the main body portion has an outer surface, a part of the outer surface being the contact surface, and
the contact surface is a curved surface projecting toward the abutting portion.

10. The haptic device according to claim 5, wherein
the housing further includes a wide portion at a leading end, of the projecting portion, on a side opposite to a base end, the base end being an end on the main body portion side, and
when a virtual straight line passing through the first portion and the second portion of the band is drawn, a maximum dimension of the wide portion in a direction parallel to the virtual straight line is larger than a minimum dimension of the projecting portion in the direction parallel to the virtual straight line.

11. The haptic device according to claim 2, wherein
the housing includes a main body portion accommodating the vibration body,
the main body portion has an outer surface, a part of the outer surface being the contact surface, and
the contact surface is a curved surface projecting toward the abutting portion.

12. The haptic device according to claim 3, wherein
the housing includes a main body portion accommodating the vibration body,
the main body portion has an outer surface, a part of the outer surface being the contact surface, and
the contact surface is a curved surface projecting toward the abutting portion.

13. The haptic device according to claim 4, wherein
the housing includes a main body portion accommodating the vibration body,
the main body portion has an outer surface, a part of the outer surface being the contact surface, and
the contact surface is a curved surface projecting toward the abutting portion.

14. The haptic device according to claim 5, wherein
the housing includes a main body portion accommodating the vibration body,
the main body portion has an outer surface, a part of the outer surface being the contact surface, and
the contact surface is a curved surface projecting toward the abutting portion.

15. The haptic device according to claim 6, wherein
the housing includes a main body portion accommodating the vibration body,
the main body portion has an outer surface, a part of the outer surface being the contact surface, and
the contact surface is a curved surface projecting toward the abutting portion.

16. The haptic device according to claim 7, wherein
the housing includes a main body portion accommodating the vibration body,
the main body portion has an outer surface, a part of the outer surface being the contact surface, and
the contact surface is a curved surface projecting toward the abutting portion.

17. The haptic device according to claim 8, wherein
the housing includes a main body portion accommodating the vibration body,
the main body portion has an outer surface, a part of the outer surface being the contact surface, and
the contact surface is a curved surface projecting toward the abutting portion.
